(19) United States
(12) Patent Application Publication
(10) Pub. No.: US 2023/0076410 A1
(43) Pub. Date: Mar. 9, 2023

(54) CAMERA SYSTEM FOR A MOTOR VEHICLE

(71) Applicant: MOTOROLA SOLUTIONS, INC., Chicago, IL (US)

(72) Inventors: CHI T. TRAN, NAPERVILLE, IL (US); RYAN M. NILSEN, PLANTATION, FL (US); FELIPPE MORAIS BICUDO, LIGHTHOUSE POINT, FL (US)

(21) Appl. No.: 17/469,757

(22) Filed: Sep. 8, 2021

(51) Int. Cl. B60R 11/04; H04N 5/225; G03B 17/02

(52) U.S. Cl. CPC B60R 11/04; H04N 5/2257; H04N 5/2252; G03B 17/02; B60R 2011/0026

(57) ABSTRACT

A video camera system comprises an elongate camera housing (102) extending along a longitudinal axis (104); a camera lens (106) disposed axially along the longitudinal axis (104) at a distal end of the camera housing, such that the camera lens faces away from the elongate camera housing; a mount (108) including a receptacle (110) to hold the camera housing (102) secured against a vehicular windshield (302) of a motor vehicle, the mount including a first region having a first opening (112); and visually perceptible light indicators (114) positioned on the elongate camera housing (102) at a location such that the visually perceptible light indicators are viewable through the first opening (112) of the mount (108), the visually perceptible light indicators (114) providing an indication of an operational status of the camera system viewable through the vehicular windshield (302) from a location outside of the motor vehicle.

### FIELD OF THE INVENTION

The present invention relates generally to video cameras and more particularly to a camera system for mounting to a windshield of a motor vehicle.

### BACKGROUND

Video cameras are increasingly being used in motor vehicles, such as law enforcement motor vehicles. The functionality now being required of such devices is becoming more challenging to integrate within a camera system. When a user, such as a police officer, is positioned outside of the vehicle it can be difficult to ascertain the current functionality of the camera, as the viewing capability may be blocked by brackets and mounting apparatus.

Accordingly, there is a need for an improved camera system that facilitates viewing of camera functionality.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a camera system in accordance with some embodiments.

FIG. 2 shows the viewing of light indicators of FIG. 1 in accordance with some embodiments.

FIG. 3A is an exploded view of the camera system in accordance with some embodiments.

FIG. 3B shows the camera system mounted to a vehicular windshield in accordance with some embodiments.

FIG. 3C shows an accessory coupled to the camera system mounted in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in a camera system which facilitates the ability to provide and view functional indicators. Accordingly, the components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

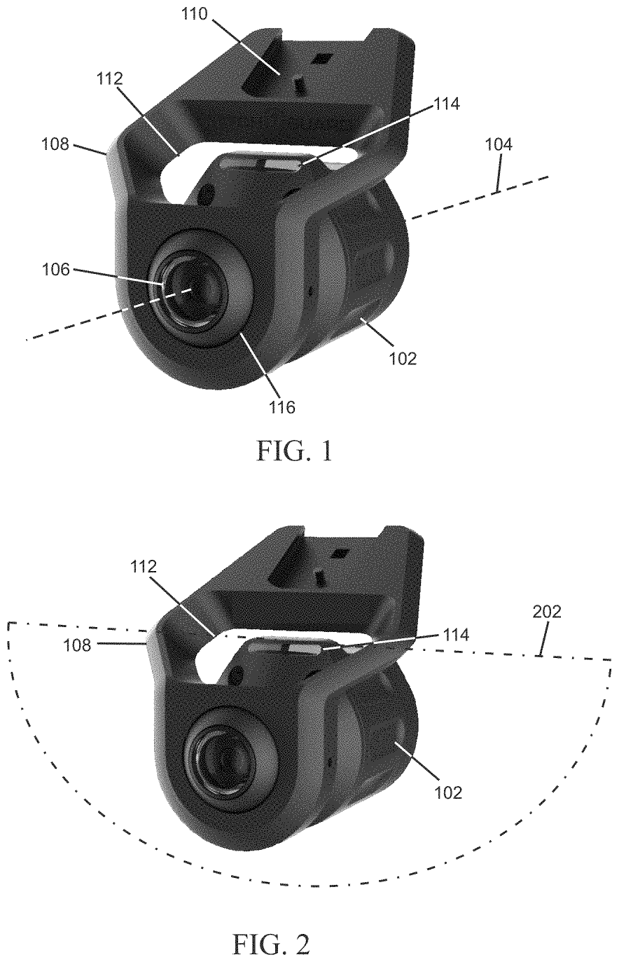

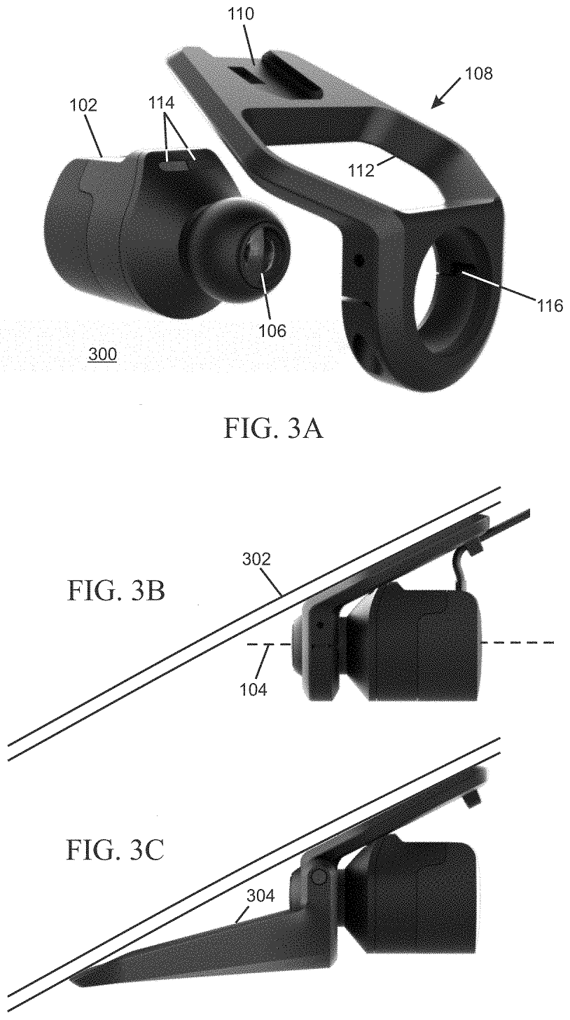

FIG. 1 is a camera system 100 in accordance with some embodiments. The camera system 100 comprises an elongate camera housing 102 extending along a longitudinal axis 104, a camera lens 106 disposed axially along the longitudinal axis 104 at a distal end of the camera housing, such that the camera lens faces away from the elongate camera housing, a mount 108 including a receptacle 110 to hold the camera housing 102 secured against a vehicular windshield (such as windshield 302 shown in FIG. 3B of a motor vehicle, the mount including a first region having a first opening 112. In accordance with the embodiments, the camera system 100 further comprises visually perceptible light indicators 114 positioned on the elongate camera housing 102 at a location such that the visually perceptible light indicators are viewable through the first opening 112 of the mount 108, the visually perceptible light indicators 114 providing an indication of an operational status of the camera system viewable through the vehicular windshield 302 from a location outside of the motor vehicle. the mount further comprises: The mount 108 further comprises a second region having a second opening 116 through which the camera lens 106 is mounted.

In accordance with some embodiments, the operational status of the camera system is one of a camera on function, camera on and recording function, and camera off function. For example, a green light may represent the camera on function, a red light may indicate the camera recording function, and the lights being off may indicate the camera off indicator function. In accordance with some embodiments, the operational status of the camera system provided by visually perceptible light indicators 114 may also provide a low storage memory indicator function of the camera system, such as a digital video recorder (DVR) of the camera system.

The camera system 100 is provided with at least one microprocessor, memory, and video analytics capability (not shown). The camera system may be powered by a vehicular battery and interoperates with radio communications equipment within the vehicle as well as external communication systems, such as public safety radio systems via a server, such as a wireless cloud based server. In accordance with some embodiments, the visually perceptible light indicators 114 of the camera system 100 may further provide an indication of a dispatched emergency alert received from the external communication systems.

In accordance with some embodiments, the visually perceptible light indicators 114 of the camera system 100 may further provide an indication of one of a plurality of triggered preset functions associated with the motor vehicle itself. For example, a vehicle door being opened or closed, a broken window, or conditions within the vehicle exceeding predetermined thresholds, such a temperature exceeding a predetermined threshold. These indicators provide the benefit of maintaining vehicle safety and minimization of acts of vandalism against the vehicle.

In accordance with some embodiments, the visually perceptible light indicators 114 of the camera system 100 may further indicate one of a plurality of contextual awareness functions from video and video analytics derived by the camera system. Such indicators may provide, for example, a “be on the lookout” (BOLO) alert, warrant alert, or other computer aided dispatch (CAD) alert indicating that an individual. approaching the vehicle within the field of view of the camera system 100 may be a suspect or subject to a warrant. The operational status may indicate, for example, a license plate recognition (ALPR) alert (e.g. a HOT HIT), in response to a vehicle plate being recorded and analyzed. These alerts are advantageously viewable by an officer/user standing outside of the vehicle improving safety conditions.

The visually perceptible light indicators 114 may provide operational status using a plurality of colors, flashing lights, and intermittent pulses, such as a pulsed 10-code communication function. Using a pulsed code indication may be used to provide a non-verbal communication indicative of, for example, a warrant or potential suspect, to the officer without alerting the individual being recorded.

FIG. 2 shows the visually perceptible light indicators 114 being visible across 180 degrees 202. This improved visibility allows for improved non-verbal communication to be viewed in front of the vehicular windshield from outside of the motor vehicle.

FIG. 3A is an exploded view 300 of the camera system of FIG. 1 formed in accordance with some embodiments. Again, the camera system 100 comprises the elongate camera housing 102 extending along a longitudinal axis 104, the camera lens 106 disposed axially along the longitudinal axis 104 at a distal end of the camera housing, such that the camera lens faces away from the elongate camera housing. The mount 108 includes a receptacle 110 to hold the camera housing 102 and for securing against the vehicular windshield 302 (FIG. 3B, 3C) of a motor vehicle, the mount including a first region having a first opening (112); The visually perceptible light indicators 114 are positioned on the elongate camera housing 102 at a location such that the visually perceptible light indicators are viewable through the first opening 112 of the mount 108 when assembled. The visually perceptible light indicators 114 provide an indication of an operational status of the camera system viewable through the vehicular windshield 302 from a location outside of the motor vehicle. This improved viewability of the light indicators 114 facilitates viewing of camera functionality, and may further provide non-verbal information pertaining to a status of the vehicle and/or status information pertaining to contextual awareness functions from video and video analytics derived by the camera system recordings, such as status information pertaining to a license plate or individual approaching the front of the vehicle.

FIG. 3B shows the camera system mounted to a vehicular windshield in accordance with some embodiments. The first region of the mount 108 having the first opening sits mounts sits flush against the vehicular windshield 302 of a motor vehicle, such as a law enforcement vehicle, and the second region having the second opening 116 extends downward from the vehicular windshield and perpendicular to the longitudinal axis 104 of the elongate camera housing 102.

FIG. 3C shows an accessory coupled to the camera system mounted in accordance with some embodiments. When mounted to a vehicular windshield, such as vehicular windshield 302 of FIG. 3B and FIG. 3C, the operational status of the camera system 100 is viewable through the vehicular windshield from a location outside of the motor vehicle. This improved viewability facilitates viewing of camera functionality, and may further provide non-verbal information pertaining to a status of the vehicle, and/or status information pertaining to contextual awareness functions from video and video analytics derived by the camera system recordings, such as status information pertaining to a license plate or individual approaching the front of the vehicle.

FIG. 3C shows an accessory coupled to the camera system mounted in the vehicle accordance with some embodiments. The accessory comprises an anti-reflection shroud accessory 304 coupled, such as by snaps, screws, or hooks, to the second region of the mount 108. The anti-reflection shroud accessory can be added to reduce glare and reflections from the windshield 302 to optimize video quality.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A camera system (100) comprising:
an elongate camera housing (102) extending along a longitudinal axis (104);
a camera lens (106) disposed axially along the longitudinal axis (104) at a distal end of the camera housing, such that the camera lens faces away from the elongate camera housing;
a mount (108) including a receptacle (110) to hold the camera housing (102) secured against a vehicular windshield (402) of a motor vehicle, the mount including a first region having a first opening (112); and
visually perceptible light indicators (114) positioned on the elongate camera housing (102) at a location such that the visually perceptible light indicators are viewable through the first opening (112) of the mount (108), the visually perceptible light indicators (114) providing an indication of an operational status of the camera system viewable through the vehicular windshield (302) from a location outside of the motor vehicle.

2. The camera system of claim 1, wherein the mount (108) further comprises: a second region having a second opening (116) through which the camera lens (106) is mounted.

3. The camera system of claim 1, wherein the operational status is one of a camera on, camera on and recording, and camera off function.

4. The camera system of claim 1, wherein the operational status is a low storage memory indicator function of the camera system.

5. The camera system of claim 1, wherein the operational status is a low storage memory indicator function of a digital video recorder (DVR) of the camera system.

6. The camera system of claim 1, wherein the visually perceptible light indicators providing an indication of an operational status of the camera system further provide an indication of one of a plurality of triggered preset functions associated with the motor vehicle.

7. The camera system of claim 1, wherein the visually perceptible light indicators indicate one of a plurality of contextual awareness functions associated with video and video analytics derived by the camera system.

8. The camera system of claim 1, wherein the operational status is a pulsed 10-code communication function.

9. The camera system of claim 1, wherein the operational status is a pulsed code indication providing a non-verbal communication indicative of a warrant.

10. The camera system of claim 1, wherein the operational status indicates a dispatched emergency alert.

11. The camera system of claim 1, the operational status indicates a license plate recognition (ALPR) alert.

12. The camera system of claim 1, the operational status indicates a computer aided dispatch (CAD) alert.

13. The camera system of claim 2, wherein the first region of the mount having the first opening sits mounts flush against the vehicular windshield (302) of the motor vehicle, and the second region having the second opening (116) extends downward from the vehicular windshield and perpendicular to the longitudinal axis of the elongate camera housing (102).

14. The camera system of claim 1, wherein the visually perceptible light indicators are visible across 180 degree in front of the vehicular windshield from outside of the motor vehicle.

15. The camera system of claim 1, further comprising an anti-reflection shroud accessory coupled to the second region of the mount.

16. The camera system of claim 15, wherein the anti-reflection shroud accessory optimizes video quality.

17. The camera system of claim 1, wherein the camera system is mounted to the vehicular windshield of a law enforcement vehicle.
